(19) United States
(12) Patent Application Publication
(10) Pub. No.: US 2002/0192387 A1
(43) Pub. Date: Dec. 19, 2002

(54) Composites with improved foam-metal adhesion

(76) Inventors: Rajat K. Agarwal, Rochester Hills, MI (US); Scott J. Beleck, St. Clair Shores, MI (US)

Correspondence Address: HENKEL CORPORATION, 2500 RENAISSANCE BLVD, STE 200, GULPH MILLS, PA, 19406, US

(21) Appl. No.: 09/873,525

(22) Filed: Jun. 4, 2001

(51) Int. Cl. B32B 3/26; B05D 1/36

(52) U.S. Cl. 427/407.1; 428/317.1; 428/319.1

(57) ABSTRACT

The resistance of a composite containing a metal carrier and an expanded thermoset resin to adhesive failure may be enhanced by phosphating the surface of the metal carrier to provide a phosphate conversion coating prior to forming the composite.

### BACKGROUND OF THE INVENTION

1. Field of the Invention

This invention relates to composites such as preformed parts which contain both a metal component and a thermoset foam component. In particular, the invention pertains to methods of enhancing the adhesion characteristics of the thermoset foam component by pretreating the surface of the metal component in contact with the thermoset foam component to form a phosphate conversion coating.

2. Discussion of the Related Art

It is known that a number of industries, e.g., the automobile industry, require parts that are both strong and light-weight. One attempt to achieve this balance between strength and minimal weight provides for hollow metal parts. However, hollow metal parts are easily distorted. Accordingly, it is also known that the presence of structural foam in the cavities of the hollow parts can improve the strength and stiffness of such parts.

Generally, such foams comprise a thermosettable resin such as an epoxy resin, a blowing agent and a filler such as hollow glass microspheres. Preferably, these foams have a density of about 20-40 lb/ft³ (about 0.30-0.65 g/cc) and are able to withstand heat in excess of 175° C., most preferably in excess of 200° C. Optional ingredients include curatives, processing aids, stabilizers, colorants, and UV absorbers.

Specific formulas for structural foam can vary widely. For example, U.S. Pat. No. 5,575,526 teaches several structural foams based on polyester and epoxy resins. U.S. Pat. No. 5,755,486 discloses thermally expandable resin-based materials containing, for example, epoxy resin, acrylonitrile-butadiene rubber, calcium carbonate, carbon black, fumed silica, glass spheres, curing agent, accelerator, and blowing agent. Structural reinforcement foams such as, e.g., TEROCORE® (a product of Henkel Surface Technologies) are now used in a variety of industries.

One characteristic of structural reinforcement foams is that they start as expandable resins that form gas pockets (cells) when cured. When exposed to ordinary environmental conditions, these cells can trap salt water. Salt and water corrode the metal parts, which are commonly in contact with the foam, and the resulting metal oxide degrades the ability of the foam to adhere to the metal. Eventually, the foam separates from the metal part, thereby weakening the part.

### SUMMARY OF THE INVENTION

The inventors have found that the adhesion of an expanded thermoset resin composition to a surface of a metal carrier may be improved by pretreating the metal surface to form a phosphate conversion coating. Pretreatment of the carrier with a phosphating composition prior to placing the carrier in contact with an expandable thermosettable resin composition provides an adhesive bond, once the resin composition has been foamed and cured, that is resistant to corrosion, degradation and loss of adhesion when the composite thus produced is exposed to severe environmental conditions.

### DETAILED DESCRIPTION OF THE INVENTION

Expandable thermosettable resin compositions useful in the present invention may be any of the formulations known in the art which, upon application of heat (from an external source and/or from the exothermic reaction of the formulation components), foam and cure to provide a body which has reduced density as compared to the initial unexpanded composition and which comprises a cross-linked polymeric matrix. Suitable expandable thermosettable resin compositions are described, for example, in the following publications, each of which is incorporated herein by reference in its entirety: U.S. Pat. No. 4,861,097; 4,901,500; 4,922,596; 4,923,902; 4,995,545; 4,978,562; 5,124,186; 5,575,526; 5,884,960; 6,068,424; 6,096,403; 6,003,274; 5,755,486; 6,058,673; 6,110,982; 5,888,600; 6,103,784; 6,199,940; 5,595,623; 6,040,350; 5,274,006; 5,470,886; 5,712,317; 5,804,608; 5,996,167; U.S. Ser. No. 09/15966 (filed Nov. 17, 2000); United Ser. No. 09/668,671 (filed Sep. 22, 2000); published International applications WO 99/08854; WO 00/27920; WO 93/05103; WO 00/52086; and WO 00/12595 and EP 891,918.

Particularly suitable formulations include one component (i.e., blowing agents which are only activated when heated to an elevated temperature (one-part) systems comprising one or more epoxy resins, one or more latent blowing agents, and one or more latent curatives (i.e., curing agents which are only activated when heated to an elevated temperature). Optional but generally preferred additional ingredients include one or more of the following: fillers (e.g., glass fibers, hollow glass microspheres, calcium carbonate, wollastonite), rubbers/elastomers, thermoplastic resins, blowing agent accelerators, colorants, thixotropic agents, and coupling agents (e.g., silanes, organotitanates, organozirconates). Two component (two-part) systems are also suitable for use in the present invention. In such systems, one component contains epoxy resin and the other component contains one or more curatives capable of initiating reaction of the epoxy resin when the two components are combined at ambient temperatures. One or both of the components may additionally contain any of the aforementioned additional ingredients. One part and two part expandable thermosettable resin compositions especially suitable for use in the present invention are available under the trademark TEROCORE from the Surface Technologies division of Henkel Corporation, Madison Heights, Mich.

The shape, configuration, and other characteristics of the metal carrier component of the present invention are selected based on the particular performance requirements of the final composite which are desired. Where, for example, reinforcement of a cavity within a motor vehicle is needed, the metal carrier is designed to fit within such cavity and to position the expandable thermosettable resin composition fastened thereon in a manner such that the composition when foamed comes into contact with and bonds securely to one or more other surfaces within the cavity in addition to one or more surfaces of the metal carrier. The metal carrier may also be configured so as to optimize the amount of expandable thermosettable resin composition used (the use of an excess of expandable thermosettable resin composition is uneconomical; if too little is used, insufficient structural reinforcement may be achieved).

The use of metal carriers in combination with expandable thermosettable resin compositions is well known and is described in more detail, for example, in the following publications, all of which are incorporated herein by reference in their entirety: U.S. Pat. Nos. 5,575,526; 5,884,960; 6,168,226; 6,068,424; 6,096,403; 6,003,274; 5,755,486; 6,058,673; 5,888,600; 6,165,588; 6,079,180; 6,092,864; 5,642,914; 4,810,548; 5,089,311; 5,213,391; 5,904,024; published PCT application WO 00/41916; and Japanese applications H 03-118179 and H 07-031569.

The metal carrier may comprise any suitable metal which is capable of forming a phosphate conversion coating thereon such as, for example, steel, aluminum, zinc, galvanized steel, and the like. Metal carriers comprised of iron (e.g., alloys of iron such as steel and galvanized steel, sometimes also referred to as ferriferous metals) are especially suitable for use since such metals are inexpensive and yet ordinarily are particularly susceptible to corrosion. In order to minimize the weight of the preformed part, it will frequently be desirable to fabricate the metal carrier from a relatively thin metal sheet, which is stamped, cut, bent or otherwise formed into the desired shape and configuration. The preformed part may comprise more than one metal carrier and may also contain components other than the metal carrier(s) and the expandable thermosettable resin composition. For example, a protective sheet of release paper or plastic film may be applied to an exposed surface of the thermosettable resin composition (particularly where such exposed surface is tacky). The protective sheet facilitates handling and minimizes contamination of the exposed surface by dust and dirt; once the preformed part is positioned in the portion of a motor vehicle where reinforcement is desired, the protective sheet is removed prior to activation (foaming and curing) of the thermosettable resin composition.

The pretreatment step of the present invention utilizes the generically well known process variously called “phosphating”, “phosphatizing”, or “phosphate conversion coating” in which a metallic substrate is coated with an adherent coating containing phosphate anions and metal cations, at least some of these metal cations being those corresponding to one or more metallic constituent(s) of the substrate. If the phosphating composition also contains divalent cations that can form only sparingly water-soluble phosphates, the conversion coating formed also normally includes some of these divalent cations from the phosphating composition.

Normally, a phosphate coating is formed by chemical reaction between the metal substrate and an aqueous liquid variously called a “phosphating” or “phosphatizing” composition, solution, bath, or a like term; in some instances, the formation of the coating may be aided by, or even completely dependent on, application of an electric current. If the phosphating composition is in contact with the substrate for at least about five seconds at a temperature not more than 70° C. and any liquid phosphating composition remaining in contact with the conversion coating thus formed is rinsed off before the substrate treated with it is dried, the phosphate coating formed generally is microcrystalline, particularly if the substrate and/or the phosphating composition contains substantial amounts of iron and/or zinc. If the phosphating composition is applied to the substrate and dried in place without rinsing, the coating formed is usually predominantly amorphous.

Phosphating is described in the following general sources, incorporated by reference therein in their entirety: “Metal Surface Treatments”, Kirk-Othmer Encyclopedia of Chemical Technology, 4^{th} Edition, Volume 16, pp. 436-441 (1992); “Phosphate Coating”, Metals Handbook-Ninth Edition, Volume 5 (Surface Cleaning, Finishing and Coating), pp. 434-456 (1982).

Suitable phosphate conversion coatings for purposes of the present invention include, but are not limited to, zinc phosphate coatings, iron phosphate coatings, manganese phosphate coatings, and calcium-, nickel-, and manganese-modified zinc phosphate coatings. Liquid concentrates and powders for a wide variety of conversion coatings suitable for use in the invention are available under the BONDERITE trademark from the Surface Technologies division of Henkel Corporation.

The phosphating process cycle to which the metal carrier is subjected may comprise one or more of the following steps (in addition to the required contacting with the working phosphate composition):

a) Cleaning of the surface of the metal carrier using one or more cleaning agents;

b) Rinsing to remove the cleaning agents used in (a);

c) Pretreatments other than phosphating (e.g., application of “Jemstedt salts”);

d) Rinsing of the metal carrier surface coated with the working phosphate composition (water rinse and/or other aftertreatment rinse);

e) Drying

Non-exclusive examples of conventional phosphating compositions suitable for use in pretreating the metal carrier to be combined with an expandable thermosettable composition according to this invention include those described in the following U.S. Patents and applications therefor, the entire disclosures of which, except to any extent that they may be inconsistent with any explicit statement herein or with other more recently developed knowledge in the art, are hereby incorporated herein by reference: U.S. National application Ser. Nos. 08/344,829; 08/464,609; 08/638,268 and 60/036,606; PCT Application Nos. U.S. Ser. Nos. 96/19144; and 96/02677; and U.S. Pat. Nos. 5,900,073; 5,776,265; 6,071,435; 5,932,292; 5,891,268; 5,645,650; 5,683,816; 5,595,611; 5,498,300; 5,472,522; 5,451,271; 5,378,292; 5,261,973; 5,143,562; 5,125,989; 5,082,511; 5,073,196; 5,045,130; 5,000,799; 4,992,116; 4,961,794; 4,927,472; 4,880,467; 4,874,480; 4,849,031; 4,722,753; 4,717,431; 4,673,444; 4,643,778; 4,639,295; 4,637,838; 4,612,060; 4,596,607; 4,595,424; 4,565,585; 4,559,087; 4,539,051; 4,529,451; 4,517,029; 4,515,643; 4,486,241; 4,443,273; 4,419,199; 4,419,147; 4,416,705; 4,402,765; 4,385,096; 4,377,487; 4,338,141; 4,311,535; 4,292,096; 4,289,546; 4,265,677; 4,220,486; 4,142,917; 4,108,690; 4,063,968; 3,939,014; 3,932,287; 3,870,573; 3,860,455; 3,850,700; 3,839,099; 3,795,548; 3,758,349; 3,723,334; 3,723,192; 3,706,604; 3,697,332; 3,671,332; 3,645,797; 3,619,300; 3,615,912; 3,607,453; 3,573,997; 3,565,699; 3,547,711; 3,533,859; 3,525,651; 3,519,495; 3,519,494; 3,516,875; 3,515,600; 3,493,400; 3,484,304; Re 27,896; 3,467,589; 3,454,483; 3,450,579; 3,450,578; 3,450,577; 3,449,222; 3,444,007; 3,401,065; 3,397,093; 3,397,092; 3,380,859; 3,338,755; 3,297,493; 3,294,493; 3,294,593; 3,268,367; 3,240,633; 3,218,200; 3,197,344; 3,161,549; 3,154,438; 3,146,133; 3,133,005; 3,101,286; 3,046,165; 3,015,594; 3,007,817; 2,979,430; 2,891,884; 2,882,189; 2,875,111; 2,840,498; 2,835,618; 2,835,617; 2,832,707; 2,819,193; 2,813,814; 2,813,813; 2,813,812; 2,798,829; 2,758,949; 2,744,555; 2,743,204; 2,724,668; 2,702,768; 2,665,231; 2,657,156; 2,609,308; 2,591,479; 2,564,864; 2,540,314; 2,298,312; 2,298,280; 2,245,609; 2,132,883; 2,121,574; 2,121,520; 2,120,212; 2,114,151; 2,076,869; 1,660,661; 1,654,716; 1,651,694; 1,639,694; 1,610,362; 1,485,025; 1,388,325; 1,377,174; 1,341,100; 1,320,734; 1,317,351; 1,292,352; 1,290,476; 1,287,605; 1,254,264; 1,254,263; 1,248,053; 1,219,526; 1,215,463; and 1,206,075.

A composition used to form the conversion coating on the metal carrier according to the invention must contain phosphate anions. They may be supplied to the composition by any oxyacid of phosphorus, or water-soluble salt thereof, in which the phosphorus is in its +5 valence state, i.e., orthophosphoric acid, metaphosphoric acid, and the condensed phosphoric acids corresponding to the general formula H₍ₙ₊₂₎PₙO₍₃ₙ₊₁₎, where n represents a positive integer with a value of at least 2. As is generally known in the art, these species are all believed to exist in equilibrium with one another, with the equilibrium strongly favoring the more condensed acids, including metaphosphoric acid, and/or their salts at higher temperatures and concentrations. At least for reasons of economy, simple orthophosphoric acid, for which the chemical formula is H₃PO₄, and/or at least one salt thereof, is normally preferred as the source for the phosphate ions.

A working composition used to prepare the desired conversion coating preferably also contains zinc cations, which may be supplied to the composition by dissolving therein any suitable zinc salt or a combination of acid and elemental zinc, zinc oxide, or zinc hydroxide. If a substrate being coated is predominantly elemental zinc, an adequate and even a preferred amount of zinc can be dissolved into the working composition from the substrate before the working composition dries. Normally, however, in order to avoid substantial variations in coating quality, it is preferred to provide zinc cations in a controlled concentration to the working composition before the latter is contacted with the substrate to be coated. For convenience, freedom from contaminants that can cause quality problems in the coatings formed, and economy, either zinc oxide or zinc dihydrogen phosphate is preferred as a source of zinc ions for the working compositions.

Independently, working composition preferably contains manganese cations. The most preferred source for these manganese cations is manganous oxide, which dissolves in acidic aqueous solutions to supply manganese cations.

Independently, the working composition preferably contains nickel cations, the preferred source of which is nickel phosphate.

Independently, the working composition used in the invention preferably contains at least one of (i) hydroxylamine, in free or bound form and (ii) iron cations. Any iron cations present preferably are predominantly in the ferrous oxidation state, inasmuch as ferrous phosphate is considerably more water soluble than ferric phosphate. Any iron salt or oxide, or even iron metal (which will dissolve in acidic solutions, accompanied by hydrogen gas evolution) may be used as the source; ferrous sulfate is most preferred for convenience and economy.

Instead of iron cations, hydroxylamine may be used at least equally preferably. Oximes can also serve as a suitable source of hydroxylamine. Hydroxylamine sulfate is most preferred for economy and because sulfate is believed to contribute to the storage stability of highly concentrated phosphating compositions.

The working composition used for phosphating may also contain any of the additional divalent cations cobalt, magnesium, calcium, copper, and the like, often found useful in conventional phosphating compositions.

When the substrates (carriers) to be treated are predominantly zinciferous or similarly electrochemically active, no accelerator is generally needed in the phosphating composition, while if the substrates are predominantly ferriferous, an accelerator may be advantageous. Adequate guidance as to suitable accelerators is provided by the prior phosphating art. For example, a dissolved accelerator component may consist of at least one of: chlorate ions; nitrite ions; m-nitrobenzoate ions; p-nitrophenol; hydrogen peroxide in free or bound form; hydroxylamine in free or bound form; and a reducing sugar.

The working phosphating composition may be applied to a metal work piece (carrier) by any convenient method, several of which will be readily apparent to those skilled in the art. For example, coating the metal with a liquid film may be accomplished by immersing the surface in a container of the liquid composition, spraying the composition on the surface, coating the surface by passing it between upper and lower rollers with the lower roller immersed in a container of the liquid composition, and the like, or by a mixture of methods. Excessive amounts of the liquid composition that might otherwise remain on the surface prior to drying may be removed by any convenient method, such as drainage under the influence of gravity, squeegees, passing between rolls, and the like.

Following the formation of a phosphate conversion coating on the surface of the metal carrier, said surface is brought into contact with the expandable thermosettable composition. For ease of subsequent handling in one embodiment of the invention, it is preferred that the expandable thermosettable resin composition be attached or fastened in some manner to the metal carrier so as to hold the expandable thermosettable resin composition in a desired position prior to activation. This will enable the assembly of a preformed part comprised of the expandable thermosettable composition and the phosphate conversion-coated metal carrier which can be easily packaged and shipped to a further manufacturing facility where it is to be used as a component of, for example, a motor vehicle. The preformed part can then be simply removed from the packaging and inserted or positioned in the particular region of the motor vehicle where structural reinforcement and/or acoustic dampening is needed.

In one embodiment of the invention, the expandable thermosettable resin composition is formulated to be sufficiently tacky that it will adhere directly to the metal carrier having a phosphate conversion coating thereon. Alternatively, a separate layer of adhesive such as a pressure sensitive adhesive may be used to fasten the expandable thermosettable resin composition to the metal carrier surface. In yet other embodiment, a pin, clip, or other mechanical device is employed for this purpose. Combinations of fastening methods may also be utilized.

One or more separate portions of the expandable thermosettable resin composition may be associated with a single metal carrier. It will generally be preferable to have a layer of phosphate conversion coating over the entire area where each portion of thermosettable expandable resin composition is in contact with the surface of the metal carrier. Still more preferably, the entire surface of the metal carrier is phosphated (including those areas not in contact with the resin composition). Each portion of expandable thermosettable resin composition may be formed into the particular shape needed for a given end-use application. Such shapes can include, for example, blocks, cylinders, rings, flat ribbons, beads, sheets, pellets, or the like. Forming techniques such as injection molding, extrusion, and the like may be utilized.

After the expandable thermosettable resin composition is contacted with or placed in a position proximate to the conversion coating deposited on the metal carrier surface, expansion and curing of the composition are initiated. In the embodiment of the invention where a one component (one-part) expandable thermosettable resin composition is employed, latent blowing agents and curatives are present in the composition. Heat is applied from an external source to activate these blowing agents and curatives. For example, the preformed part comprised of the expandable thermosettable resin composition and the phosphate conversion-coated metal carrier may be placed in a motor vehicle before said motor vehicle in placed in a paint oven. The paint oven causes the expandable thermosettable resin composition to foam and crosslink, with the resulting expanded thermoset effectively forming a strong adhesive bond both with the surface of the metal carrier as well as any surfaces of other components of the motor vehicle in close proximity to the preform part. The high strength, reduced density foam not only reinforces and stiffens that region of the motor vehicle by tying together a plurality of such surfaces without the increase in vehicle weight which would result if metal reinforcement were used, but often also helps to reduce noise and vibration transmission. Alternatively, a two part (two component) expandable thermosettable resin composition can be employed wherein the reaction of the two components when combined is sufficiently exothermic that application of external heat is not necessary.

Thus, in one embodiment of the invention, a method of reinforcing a reaction of an assembly wherein said reaction having a surface (e.g., a rail channel in a motor vehicle) is provided. The method comprises the steps of placing a portion of an expandable thermosettable resin composition in a position proximate to (i.e., near or touching) both said surface of said reaction and a surface of a metal carrier. The metal carrier surface is pretreated to provide a phosphate conversion coating thereon. The portion of the expandable thermosettable resin composition is cured and expanded to from an expanded thermoset resin body which is in contact with and adhered to both said surface of said reaction and said surface of said metal carrier.

A particular advantage of the present invention is that the aforedescribed improvements in structural properties may be maintained for an extended period of time as compared to assemblies which have been reinforced using preformed parts comprised of a expandable thermosettable resin composition and a metal carrier which has not been pretreated to form a phosphate conversion coating. Without the necessary phosphate conversion coating, corrosion of the metal carrier surface occurs at a more rapid rate when the assembly is exposed to water, salt spray and the like. Such corrosion ultimately results in failure of the adhesive bond between the expanded thermoset and the metal carrier, with a resulting loss in structural strength.

### EXAMPLES

To prepare composites in accordance with the invention, cold rolled steel (CRS) coupons (both oiled and unoiled) measuring 4″×1″×0.060″ were phosphated using the following procedure (unless otherwise noted, all materials identified by trademark are 20 commercial products of the Surface Technologies division of Henkel Corporation):

Stage 1—Coupons were sprayed with 5% PARCO Cleaner 472 for 1 minute at 140° F.

Stage 2—Coupons were rinsed with water for 1 minute at ambient temperature

Stage 3—Coupons were immersed in 0.5% (17 ppm Ti) FIXODINE ZL (pH=9.2) for 30 seconds at 120° F.

Stage 4—Coupons were immersed in BONDERITE 958 phosphating solution for 2 minutes at 115° F.

Stage 5—Coupons were rinsed with water for 1 minute at ambient temperature

Stage 6—Coupons were immersed in 0.75% PARCOLENE 99A (pH=6.0) for 30 seconds at ambient temperature

Stage 7—Coupons were rinsed with deionized water for 20 seconds at ambient temperature

Stage 8—Coupons were dried in a 300° F. oven for 5 minutes

The phosphate conversion-coated coupons were prepared for lap shear testing by overlapping a 1 in² area of two cold rolled steel (CRS) coupons (coupon thickness=0.060 in) and placing TEROCORE 1010B resin (product of the Surface Technologies division of Henkel Corporation) between the coupons in the overlap area to provide a bond thickness of 4 mm. The TEROCORE 1010B resin was thereafter cured and expanded by heating to provide composites comprised of a layer of thermoset foam adhered to metal carriers (the coupons).

The bond strengths of the resulting composites were measured at a pull rate of 12 mm/min, both before and after the composites were subjected to APGE cyclic corrosion testing.

TABLE 1

| Type of | Max Load | Max Load | Max Load |
|---|---|---|---|
| Metal Carrier | (N) Initial | (N) 5 Cycles | (N) 10 Cycles |
| CRS (oiled)* | 1811(59)** | 273(62) | 0 |
| Phosphated CRS | 1868(58) | 1515(47) | 1468(61) |
| (oiled) | | | |
| Phosphated CRS | 1986(61) | 1658(49) | 1556(56) |
| (unoiled) | | | |

*comparative example
**The value in parenthesis is the standard deviation

The initial pull values on all the composites were between 1800-2000 N, with cohesive failure, regardless of whether the CRS coupons were pretreated with phosphate. However, after 5 APGE cycles, the composites which had been prepared using bare (unphosphated) CRS coupons only exhibited pull values of ca. 250-300 N and failed adhesively. The composites which had been prepared in accordance with the invention (i.e., where the CRS coupons were first treated to form a phosphate conversion coating on the surface) retained much higher pull values (ca. 1500-1700 N) and failed cohesively, rather than adhesively. This demonstrates that phosphate pretreatment of a metal carrier significantly improves the adhesion of an expanded thermoset resin to the surface of the metal carrier when the expanded thermoset resin/metal carrier composite is subjected to cyclic corrosion testing, despite the foamed structure of the expanded thermoset resin.

What is claimed is:

1. A preformed part useful for reinforcing a structural member, said preformed part comprising:
(a) a metal carrier; and
(b) an expandable thermosettable resin composition attached to a surface of said metal carrier;
wherein said surface has a phosphate conversion coating thereon.

2. The preformed part of claim 1 wherein the expandable thermosettable resin composition is comprised of one or more epoxy resins.

3. The preformed part of claim 1 wherein the expandable thermosettable resin composition is comprised of one or more epoxy resins, one or more latent blowing agents, and one or more latent curatives.

4. The preformed part of claim 1 wherein the metal carrier is comprised of iron.

5. The preformed part of claim 1 wherein the phosphate conversion coating is selected from the group consisting of zinc phosphate coatings, iron phosphate coatings, manganese phosphate coatings, calcium-modified zinc phosphate coatings, nickel-modified zinc phosphate coatings and manganese-modified zinc phosphate coatings.

6. The preformed part of claim 1 wherein the expandable thermosettable resin composition is tacky and is self-adhered to said surface of said metal carrier.

7. The preformed part of claim 1 wherein the expandable thermosettable resin composition is attached to said surface of said metal carrier using an adhesive.

8. The preformed part of claim 1 wherein the expandable thermosettable resin composition is attached to said surface of said metal carrier by one or more mechanical devices.

9. A structural composite comprised of:
(a) a metal carrier; and
(b) an expanded thermoset resin adhered to a surface of said metal carrier,
wherein said surface has been pretreated to form a phosphate conversion coating.

10. The structural composite of claim 9 wherein said expanded thermoset resin is additionally adhered to at least one other surface other than said surface of said metal carrier.

11. The structural composite of claim 9 wherein said expanded thermoset resin is obtained by heating a expandable thermosettable resin composition comprised of one or more epoxy resins, one or more latent blowing agents, and one or more latent curatives.

12. The structural composite of claim 9 wherein said metal carrier is comprised of iron.

13. The structural composition of claim 9 wherein the phosphate conversion coating is selected from the group consisting of zinc phosphate coatings, iron phosphate coatings, manganese phosphate coatings, calcium-modified zinc phosphate coatings, nickel-modified zinc phosphate coatings, and manganese-modified zinc phosphate coatings.

14. A method of reinforcing a section of an assembly wherein said section has a surface, said method comprising:
(a) placing a portion of an expandable thermosettable resin composition in a position proximate to both said surface of said section and a surface of a metal carrier, said surface of said metal carrier having a phosphate conversion coating thereon; and
(b) curing and expanding said portion of the expandable thermosettable resin composition to form an expanded thermoset resin body which is in contact with and is adhered to both to said surface of said section and said surface of said metal carrier.

15. The method of claim 14 wherein said assembly is a motor vehicle.

16. The method of claim 14 wherein the expandable thermosettable resin composition is comprised of one or more epoxy resins.

17. The method of claim 14 wherein the expandable thermosettable resin composition is a one component system.

18. The method of claim 14 wherein the expandable thermosettable resin composition is a two component system.

19. The method of claim 14 wherein the phosphate conversion coating is selected from the group consisting of zinc phosphate coatings, iron phosphate coatings, manganese phosphate coatings, calcium-modified zinc phosphate coatings, nickel-modified zinc phosphate coatings and manganese-modified zinc phosphate coatings.

20. A method of improving the adhesion of an expanded thermoset resin to a metal surface where said expanded thermoset resin and said metal surface are to be exposed to moisture, wherein the improvement comprises pretreating the portion of said metal surface which will be in contact with the expanded thermoset resin to form a phosphate conversion coating.
